(19) United States
(12) Patent Application Publication
(10) Pub. No.: US 2023/0239938 A1
(43) Pub. Date: Jul. 27, 2023

(54) DETERMINING A DEFAULT NETWORK SLICE

(71) Applicant: Telefonaktiebolaget LM Ericsson (publ), Stockholm (SE)

(72) Inventors: Peter Hedman, Helsingborg (SE); Kaj Johansson, Göteborg (SE)

(21) Appl. No.: 18/013,292

(22) PCT Filed: Jun. 29, 2021
(86) PCT No.: PCT/IB2021/055824

§ 371 Date: Dec. 28, 2022

Related U.S. Application Data
(60) Provisional application No. 63/045,602, filed on Jun. 29, 2020.

(51) Int. Cl. H04W 76/10; H04W 8/18

(52) U.S. Cl. CPC H04W 76/10; H04W 8/183

(57) ABSTRACT

Methods for determining a default network slice are provided. More specifically, the methods include determining a default Single Network Slice Selection Assistance Information (S-NSSAI) that identifies the default network slice for establishing a Protocol Data Unit (PDU) session for an application in a wireless device without an S-NSSAI association. Various embodiments for determining the S-NSSAI are also disclosed herein. By determining the default network slice, it is possible to eliminate existing ambiguity associated with establishing a PDU session for application without S-NSSAI association, thus helping to reduce implementation complexity in a wireless device and/or a core network node.

### RELATED APPLICATIONS

This application claims the benefit of provisional patent application Ser. No. 63/045,602, filed Jun. 29, 2020, the disclosure of which is hereby incorporated herein by reference in its entirety.

### TECHNICAL FIELD

The technology of the disclosure relates generally to determining a default network slice.

### BACKGROUND

In Fifth-Generation (5G) Systems (5GS), a Network Slice is identified by a Single Network Slice Selection Assistance Information (S-NSSAI). The S-NSSAI includes a Slice/Service Type (SST) and optionally a Slice Differentiator (SD) part.

There are Home Public Land Mobile Network (HPLMN) value S-NSSAI and Serving PLMN value S-NSSAI. In TS 24.501, the S-NSSAI format has two parts (e.g., one for each PLMN). While in TS 23.501 and 23.502, the differentiation is made by different information (e.g., mapping of allowed NSSAI implies the HPLMN values and allowed NSSAI implies the Serving PLMN values).

A User Equipment (UE) may provide a requested NSSAI with one or more S-NSSAIs during a registration procedure, and the UE gets the registered S-NSSAIs in an Allowed NSSAI from the network. The UE then uses one of the registered S-NSSAIs to, for example, establish a Protocol Data Unit (PDU) Session.

Which S-NSSAI to register and use (e.g., at a PDU Sessions Establishment) can be decided by a UE Route Selection Policy (URSP), which is a policy rule that can associate applications with S-NSSAIs.

A UE does not always support URSP, or the URSP does not always associate to all applications.

A UE may issue a registration request without any requested NSSAI. In such a case, a 5G Core (5GC) uses the Subscribed S-NSSAI(s), which is stored in a Unified Data Management (UDM) and marked as a default (can be none, one or more), as an allowed NSSAI.

If the UE does not provide any S-NSSAI during the PDU Session Establishment, then an Access and Mobility Management Function (AMF) selects the S-NSSAI to be used.

### SUMMARY

Embodiments disclosed herein include methods for determining a default network slice. More specifically, the methods include determining a default Single Network Slice Selection Assistance Information (S-NSSAI) that identifies the default network slice for establishing a Protocol Data Unit (PDU) session for an application in a wireless device without an S-NSSAI association. Various embodiments for determining the S-NSSAI are also disclosed herein. By determining the default network slice, it is possible to eliminate existing ambiguity associated with establishing a PDU session for application without S-NSSAI association, thus helping to reduce implementation complexity in a wireless device and/or a core network node.

In an embodiment, a method performed by a wireless device for determining a default network slice is provided. The method includes determining a default S-NSSAI that identifies a default network slice. The method also includes establishing a PDU session in the default network slice identified by the default S-NSSAI for an application without an S-NSSAI association.

In an embodiment, determining the default S-NSSAI includes registering with a network node without providing a requested NSSAI. Determining the default S-NSSAI also includes receiving, from the network node, an allowed NSSAI comprising one or more subscribed S-NSSAIs. Determining the default S-NSSAI also includes determining any of the one or more subscribed S-NSSAIs as the default S-NSSAI.

In an embodiment, determining the default S-NSSAI includes receiving, from a network node, a configured NSSAI comprising one or more marked S-NSSAIs and determining any of the one or more marked S-NSSAIs as the default S-NSSAI.

In an embodiment, determining the default S-NSSAI includes sending, to a network node, a registration request comprising an indication requesting the default S-NSSAI to be registered and identified among one or more pre-registered S-NSSAIs for an allowed NSSAI and receiving, from the network node, the allowed NSSAI comprising one or more S-NSSAIs marked as default S-NSSAI.

In an embodiment, determining the default S-NSSAI comprises receiving, from a network node, a User Equipment, UE, Route Selection Policy, URSP, rule associated with the default S-NSSAI.

In an embodiment, establishing the PDU session includes sending a new registration request comprising the default S-NSSAI.

In an embodiment, the new registration request further comprises one or more specific S-NSSAIs different from the default S-NSSAI.

In an embodiment, establishing the PDU session includes providing a PDU session establishment request to the network node.

In an embodiment, the PDU session establishment request comprises the default S-NSSAI.

In an embodiment, the PDU session establishment request does not comprise the default S-NSSAI.

In another embodiment, a wireless device is provided. The wireless device includes processing circuitry. The processing circuit is configured to cause the wireless device to determine a default S-NSSAI that identifies a default network slice and establish a PDU session in the default network slice identified by the default S-NSSAI for an application without an S-NSSAI association.

In an embodiment, the processing circuitry is further configured to cause the wireless device to perform any of the steps in the method performed by the wireless device.

In another embodiment, a method performed by an Access and Mobility Function, AMF, for determining a default network slice is provided. The method includes receiving a registration request from a wireless device. The method also includes sending, to the wireless device, a registration accept message. The registration accept message includes any one of: an allowed NSSAI comprising one or more subscribed S-NSSAIs, a configured NSSAI comprising one or more marked S-NSSAIs, the allowed NSSAI comprising one or more S-NSSAIs marked as default S-NSSAI, and a URSP rule associated with the default S-NSSAI.

In an embodiment, the registration request does not comprise a requested NSSAI.

In an embodiment, the registration request comprises an indication requesting a default S-NSSAI to be registered and identified among one or more pre-registered S-NSSAIs for an allowed NSSAI.

In an embodiment, the method also includes receiving, from a Unified Data Management, UDM, subscription information comprising the one or more subscribed S-NSSAIs.

In an embodiment, the method also includes sending a request to a Network Slice Selection Function, NSSF, to request a network slice selection. The method also includes receiving a response from the NSSF comprising the network slice selection.

In an embodiment, the request includes an indication to register the one or more subscribed S-NSSAIs. The response includes one of: the one or more subscribed S-NSSAIs and the one or more marked S-NSSAIs.

In another embodiment, a network node is provided. The network node includes processing circuitry. The processing circuitry is configured to cause the network node to receive a registration request from a wireless device. The processing circuitry is also configured to cause the network node to send, to the wireless device, a registration accept message. The registration accept message includes any one of: an allowed NSSAI comprising one or more subscribed S-NSSAIs, a configured NSSAI comprising one or more marked S-NSSAIs, the allowed NSSAI comprising a default S-NSSAI, and a URSP rule associated with the default S-NSSAI.

In an embodiment, the processing circuitry is further configured to cause the network node to perform the steps in the method performed by the AMF.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIG. 2 illustrates a wireless communication system represented as a Fifth-Generation (5G) network architecture composed of core Network Functions (NFs), where interaction between any two NFs is represented by a point-to-point reference point/interface;

FIG. 3 illustrates a 5G network architecture using service-based interfaces between the NFs in a Control Plane (CP), instead of the point-to-point reference points/interfaces used in the 5G network architecture of FIG. 2;

FIG. 4 is a flowchart of an exemplary method performed by a wireless device for determining a default network slice;

FIG. 5 is a flowchart of an exemplary method performed by an Access and Mobility Function (AMF) for determining a default network slice;

FIG. 6 is a flowchart of an exemplary process that can be employed by a communication device for determining a default network slice;

FIG. 7 is a flow diagram providing a simplified signal flow of a User Equipment (UE) registration procedure employed by a network to support the embodiments of the present disclosure;

FIG. 8 is a schematic block diagram of a network node according to some embodiments of the present disclosure;

FIG. 9 is a schematic block diagram that illustrates a virtualized embodiment of the network node according to some embodiments of the present disclosure;

FIG. 10 is a schematic block diagram of the network node according to some other embodiments of the present disclosure;

FIG. 11 is a schematic block diagram of a wireless communication device according to some embodiments of the present disclosure; and

FIG. 12 is a schematic block diagram of the wireless communication device according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). There is no explicit way for a UE to determine a default Single Network Slice Selection Assistance Information (S-NSSAI).

The UE needs to know the default S-NSSAI to be registered. However, the only way for the UE to register the default S-NSSAI is to omit sending the requested NSSAI, which may cause other registered S-NSSAIs to be deregistered.

In a Protocol Data Unit (PDU) Session Establishment, if the UE does not include any S-NSSAI, it is assumed that the network selects the S-NSSAI to be used from the allowed NSSAIs. However, there are opinions that there need to be other means to enable default S-NSSAIs to be used.

Also, UE Route Selection Policy (URSP) is seen as too complex by UE vendors. For example, the mechanisms used to refer to applications are not easy to implement. As a result, there may be an immediate risk that URSP is not implemented, and other means may be used to associate applications to S-NSSAIs.

Certain aspects of the present disclosure and their embodiments may provide solutions to the aforementioned or other challenges. The UE is provided with the information as to which S-NSSAI is to be used as the default S-NSSAI (e.g., in a PDU Session Establishment) in case there is no S-NSSAI association to the application to be used.

There are, proposed herein, various embodiments which address one or more of the issues disclosed herein.

In one embodiment, a method performed by a communication device for determining a default network slice (e.g., for establishing a PDU session) is provided. The method includes determining a default S-NSSAI that identifies a default network slice. The method also includes establishing a PDU session in the default network slice identified by the default S-NSSAI for an application without S-NSSAI association.

In another embodiment, a method performed by a network (e.g., 5GC) for determining a default network slice (e.g., for establishing a PDU session) is provided. The method includes receiving a registration request from a communication device (e.g., UE) including a requested NSSAI or without a request NSSAI. The method also includes receiving (e.g., at AMF) subscription information (e.g., from UDM) including one or more subscribed S-NSSAIs. The method also includes sending (e.g., from the AMF) a registration accept to the wireless device. The registration accept may include one or more of: one or more default S-NSSAIs; a configured NSSAI and/or an allowed NSSAI that indicate the one or more default S-NSSAIs; and an allowed NSSAI including the one or more default S-NSSAIs with an optional marking for one or more default 5-NSSAIs.

Certain embodiments may provide one or more of the following technical advantage(s). Embodiments disclosed herein enable the UE to select the S-NSSAI to be used for applications that does not have any explicit URSP association with the S-NSSAI and for applications that should be tied to the default S-NSSAI when the UE is instead registered with different S-NSSAIs.

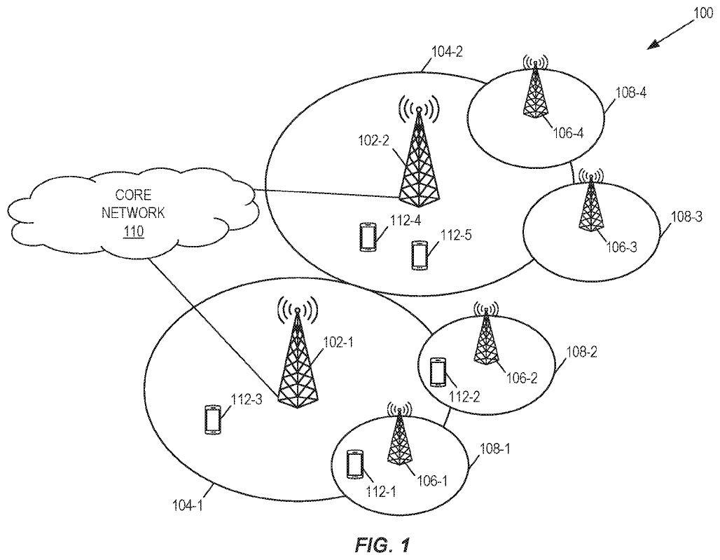

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC). In this example, the NG-RAN includes base stations 102-1 and 102-2, which in the 5GS include NR base stations (gNBs) and optionally next generation eNBs (ng-eNBs) (e.g., LTE RAN nodes connected to the 5GC), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto.

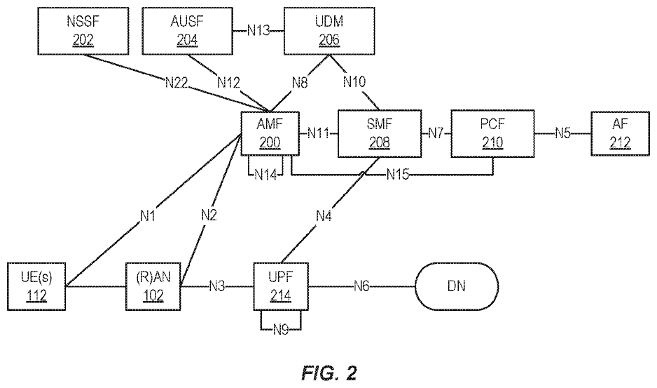

FIG. 2 illustrates a wireless communication system represented as a 5G network architecture composed of core Network Functions (NFs), where interaction between any two NFs is represented by a point-to-point reference point/interface. FIG. 2 can be viewed as one particular implementation of the system 100 of FIG. 1.

Seen from the access side the 5G network architecture shown in FIG. 2 comprises a plurality of UEs 112 connected to either a RAN 102 or an Access Network (AN) as well as an AMF 200. Typically, the R(AN) 102 comprises base stations, e.g., such as eNBs or gNBs or similar. Seen from the core network side, the 5GC NFs shown in FIG. 2 include a NSSF 202, an AUSF 204, a UDM 206, the AMF 200, a SMF 208, a PCF 210, and an Application Function (AF) 212.

Reference point representations of the 5G network architecture are used to develop detailed call flows in the normative standardization. The N1 reference point is defined to carry signaling between the UE 112 and AMF 200. The reference points for connecting between the AN 102 and AMF 200 and between the AN 102 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214, and N14 is the reference point connecting between different AMFs 200, respectively. N15 and N7 are defined since the PCF 210 applies policy to the AMF 200 and SMF 208, respectively. N12 is required for the AMF 200 to perform authentication of the UE 112. N8 and N10 are defined because the subscription data of the UE 112 is required for the AMF 200 and SMF 208.

The 5GC network aims at separating UP and CP. The UP carries user traffic while the CP carries signaling in the network. In FIG. 2, the UPF 214 is in the UP and all other NFs, i.e., the AMF 200, SMF 208, PCF 210, AF 212, NSSF 202, AUSF 204, and UDM 206, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 200 and SMF 208 are independent functions in the CP. Separated AMF 200 and SMF 208 allow independent evolution and scaling. Other CP functions like the PCF 210 and AUSF 204 can be separated as shown in FIG. 2. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

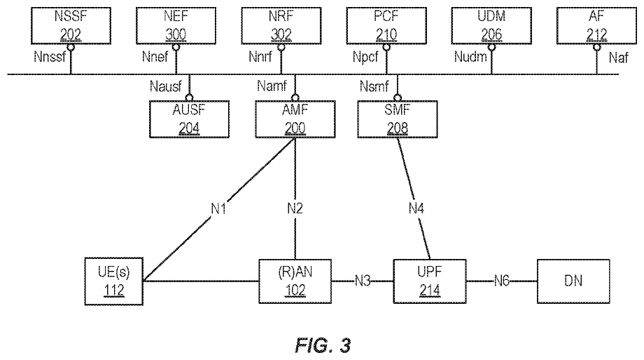

FIG. 3 illustrates a 5G network architecture using service-based interfaces between the NFs in the CP, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g. Namf for the service based interface of the AMF 200 and Nsmf for the service based interface of the SMF 208, etc. The NEF 300 and the NRF 302 in FIG. 3 are not shown in FIG. 2 discussed above. However, it should be clarified that all NFs depicted in FIG. 2 can interact with the NEF 300 and the NRF 302 of FIG. 3 as necessary, though not explicitly indicated in FIG. 2.

Some properties of the NFs shown in FIGS. 2 and 3 may be described in the following manner. The AMF 200 provides UE-based authentication, authorization, mobility management, etc. A UE 112 even using multiple access technologies is basically connected to a single AMF 200 because the AMF 200 is independent of the access technologies. The SMF 208 is responsible for session management and allocates Internet Protocol (IP) addresses to UEs. It also selects and controls the UPF 214 for data transfer. If a UE 112 has multiple sessions, different SMFs 208 may be allocated to each session to manage them individually and possibly provide different functionalities per session. The AF 212 provides information on the packet flow to the PCF 210 responsible for policy control in order to support QoS. Based on the information, the PCF 210 determines policies about mobility and session management to make the AMF 200 and SMF 208 operate properly. The AUSF 204 supports authentication function for UEs or similar and thus stores data for authentication of UEs or similar while the UDM 206 stores subscription data of the UE 112. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

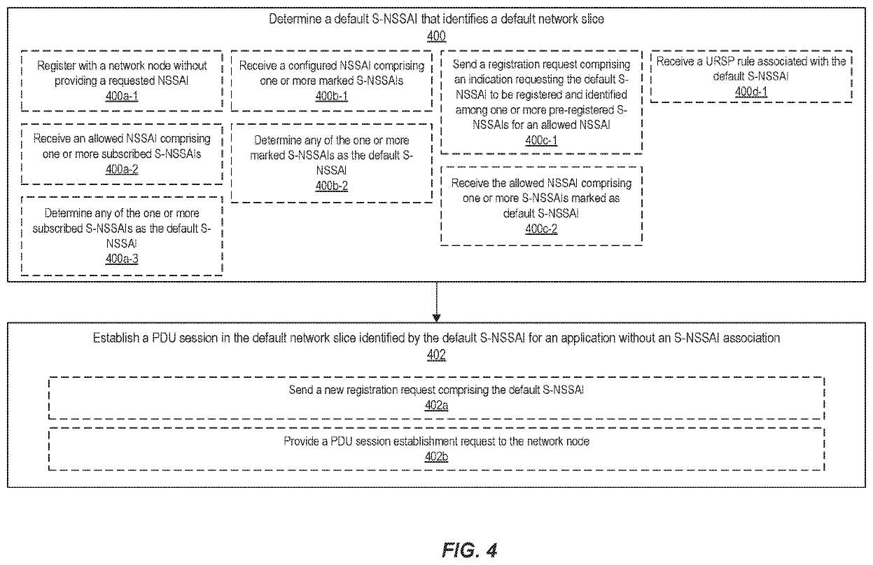

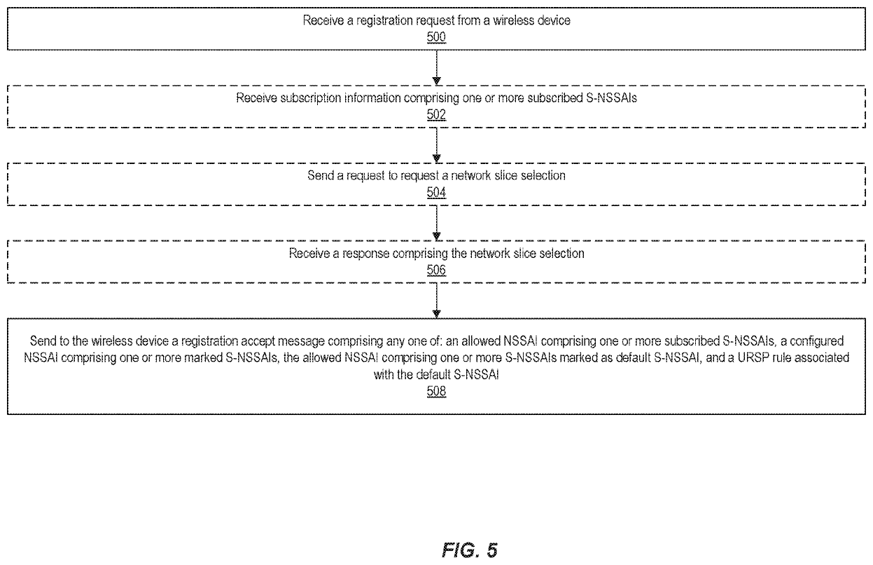

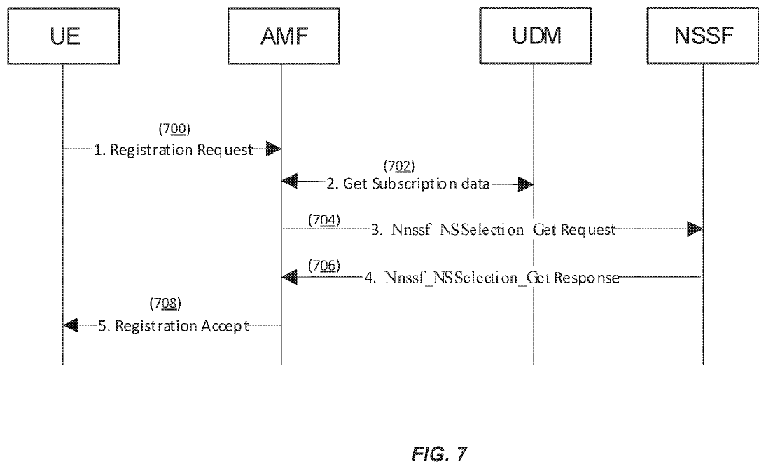

Before discussing specific embodiments of the present disclosure, starting at FIG. 7, methods performed by a wireless device and an AMF for determining a default network slice are first provided with reference to FIGS. 4 and 5, respectively.

In this regard, FIG. 4 is a flowchart of an exemplary method performed by a wireless device for determining a default network slice. The wireless device is configured to determine a default S-NSSAI that identifies a default network slice (step 400).

In one embodiment, the wireless device may register with a network node without providing a requested NSSAI (step 400a-1), receiving, from the network node, an allowed NSSAI that includes one or more subscribed S-NSSAIs (step 400a-2), and determine any of the one or more subscribed S-NSSAIs as the default S-NSSAI (step 400a-3).

In another embodiment, the wireless device may receive, from a network node, a configured NSSAI that includes one or more marked S-NSSAIs (step 400b-1) and determine any of the one or more marked S-NSSAIs as the default S-NSSAI (step 400b-2).

In another embodiment, the wireless device may send, to a network node, a registration request that includes an indication requesting the default S-NSSAI to be registered and identified among one or more pre-registered S-NSSAIs for an allowed NSSAI (step 400c-1) and receive, from the network node, the allowed NSSAI that includes the default S-NSSAI (step 400c-2).

In another embodiment, the wireless device may receive, from a network node, an URSP rule associated with the default S-NSSAI (step 400d-1).

Accordingly, the wireless device can establish a PDU session in the default network slice identified by the default S-NSSAI for an application without an S-NSSAI association (step 402).

In one embodiment, the wireless device may send a new registration request that includes the default S-NSSAI (step 402a). In another embodiment, the wireless device may provide a PDU session establishment request to the network node (step 402b).

FIG. 5 is a flowchart of an exemplary method performed by an AMF for determining a default network slice. The AMF is configured to receive a registration request from a wireless device (step 500). The AMF may also receive, from a UDM, subscription information that includes one or more subscribed S-NSSAIs (step 502). The AMF may also send a request to an NSSF to request a network slice registration (step 504). The AMF may also receive a response from the NSSF that includes a network slice selection (step 506). Accordingly, the AMF can send, to the wireless device, a registration accept message (step 508).

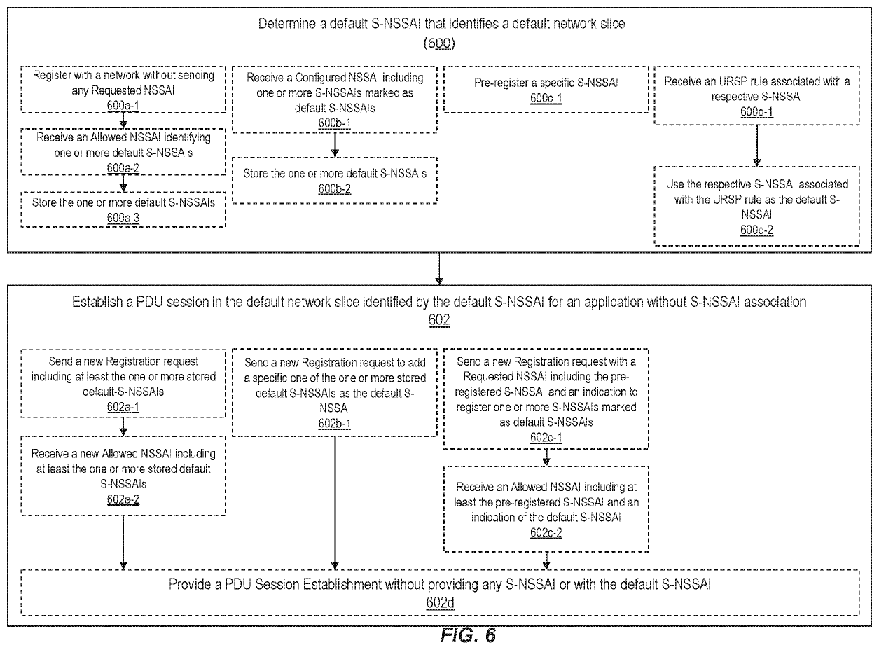

FIG. 6 is a flowchart of an exemplary process that can be employed by a communication device (e.g., a UE) for determining a default network slice (e.g., for establishing a PDU session). The method includes determining (600) a default S-NSSAI that identifies a default network slice and establishing (602) a PDU session in the default network slice identified by the default S-NSSAI for an application without 5-NSSAI association.

As discussed in detail below, there are different options, which may be used individually or in combination, as to how the UE can determine (600) the default S-NSSAI and to establish (602) a PDU session for an application without an S-NSSAI association (e.g., defined by URSP rules).

Option 1 (e.g., steps 400, 402): (option that does not require network updates)
1. The UE always first registers without sending any requested NSSAI towards a specific PLMN (e.g., step 400a-1).
2. The network provides the UE with an allowed NSSAI based on the Subscribed S-NSSAI(s) marked as default (e.g., step 400a-2). Notably, it is preferred that only one S-NSSAI is marked as default, but the 3GPP standard allows none, one or more to be marked as default in UDM.
3. The UE stores the S-NSSAI(s) received in the allowed NSSAI as the default S-NSSAI (e.g., in Default S-NSSAI list) (e.g., step 400a-3)
4. The UE may now use the S-NSSAI(s) in signaling or register more S-NSSAIs based on need. The UE may also de-register from the PLMN.
5. At a later point, the UE may first register a specific S-NSSAI.
6. If the UE has a specific S-NSSAI registered (i.e., in allowed NSSAI) and an application starts without an association to any S-NSSAI, the UE sends a new Registration request adding the stored default S-NSSAI in Requested NSSAI (e.g., step 402a). The UE may optionally include the specific S-NSSAI if the UE wants that specific S-NSSAI to be kept registered.
7. The network provides a new allowed NSSAI including default S-NSSAI. If the UE has included the specific S-NSSAI in the new Registration request, the new allowed NSSAI would also include the previously registered S-NSSAI.
8. The UE can now issue a PDU Session Establishment without providing any S-NSSAI for the application without any S-NSSAI association or the UE can provide the stored default S-NSSAI (one of them if multiple stored—if more than one then it may be better to avoid sending any and let network decide).
   Option 2 (e.g., steps 400, 402):
1. When the network provides Configured NSSAI for a PLMN to the UE (in Registration Accept or UE Configuration Update Command), the network also provides an additional indication for an S-NSSAI(s) that is marked as default S-NSSAI(s) (e.g., step 400b-1).
2. The UE stores the received information including the S-NSSAI(s) marked as default S-NSSAI(s) (e.g., 400b-2).
3. Later, the UE may first register a specific S-NSSAI.
4. If the UE has a specific S-NSSAI in allowed NSSAI and an application starts without an association to any S-NSSAI. The UE sends a new registration request adding also the S-NSSAIs stored as default S-NSSAI (e.g., step 402b).
5. UE can now issue PDU Session Establishment, without S-NSSAI or with a default S-NSSAI, for the application without any S-NSSAI association.
   Option 3 (e.g., steps 400, 402):
1. The UE has a specific S-NSSAI(s) registered in allowed NSSAI.
2. An application starts without an association to any S-NSSAI. The UE sends a new registration request with a requested NSSAI including the S-NSSAI(s) already registered and adding a new indication that the UE wants the S-NSSAI(s) marked as default S-NSSAI to be registered (e.g., 400c-1).
3. The network provides an allowed NSSAI including the S-NSSAI(s) in the requested NSSAI and also adds the S-NSSAI(s) marked as default S-NSSAI(s) from UDM. The network may also provide an additional indication in the allowed NSSAI to indicate the default S-NSSAI(s) (e.g, 400c-2).
4. UE can now issue a PDU Session Establishment, without S-NSSAI or with a default S-NSSAI, for the application without any S-NSSAI association (e.g., step 402b).
5. Whenever a new application starts that does not have association to any S-NSSAI, the UE first checks if a stored allowed NSSAI contains the default S-NSSAI. If true, then step 4 applies, otherwise step 3.
   Option 4 (e.g., steps 400, 402):
1. The UE is provided a URSP rule with a lowest Rule Precedence priority that includes a match-all Traffic Descriptor and the S-NSSAI is the one used as default S-NSSAI (e.g., step 400d-1) (see TS 23.503 last row of Table A-1: Example of URSP rules for an example).
2. The UE supports the above URSP rule independent of whether the UE supports other type of URSP rules.
3. UE uses the S-NSSAI in URSP rule as default S-NSSAI (e.g., step 400d-1).
4. If the UE has a specific S-NSSAI in allowed NSSAI and an application starts without any S-NSSAI association. The UE sends a new registration request additionally adding the S-NSSAIs stored as default S-NSSAI.
5. UE can now issue the PDU Session Establishment, without S-NSSAI or with a default S-NSSAI, for the application without any S-NSSAI association.

### UE Registration in 5GC

FIG. 7 is a flow diagram providing a simplified signal flow of the UE registration procedure defined in section 4.2.2.2.2 and 4.2.2.2.3 of TS 23.502 and employed by a network (e.g., 5GC) to support the embodiments of the present disclosure.

Step 700—The UE sends Registration Request optionally including a requested NSSAI (e.g., step 500).
Option 1: The UE always first registers to a PLMN by not sending the requested NSSAI (valid option in standard but now used to retrieve the default S-NSSAI(s))
Option 1: In a subsequent registration the UE may determine the need to register the default S-NSSAIs and then includes those in the requested NSSAI potentially with other S-NSSAIs.
Option 2: The UE has previously received configured NSSAI (and/or allowed NSSAI) with information indicating which S-NSSAI(s) is used as a default NSSAI. UE may register the default S-NSSAI(s) as well as other S-NSSAIs.
Option 3: The UE may provide a new indication in the Registration Request that the UE wants to also register the S-NSSAI(s) marked as default S-NSSAI(s).
Option 4: Based on the previously received URSP, the UE determines the default S-NSSAI and registers the default S-NSSAI when the UE has an application that is not associated to any other URSP rules.
   Step 702—The AMF gets the subscription information from the UDM including the subscribed S-NSSAIs and some may be marked as default S-NSSAIs. As per existing flow (e.g., step 502).
   Step 704—The AMF may request slice selection by sending Nnssf_NSSelection_Get Request to the NSSF (e.g., step 504).
Option 1: As per standard flow
Option 2: As per standard flow
Option 3: AMF adds indication that the UE wants to register the Subscribed S-NSSAIs marked as default S-NSSAIs
Option 4: As per standard flow
   Step 706—The NSSF replies with Nnssf_NSSelection_Get Response (e.g., step 506).
Option 1: As per standard flow
Option 2: The NSSF may provide the configured NSSAI (and/or allowed NSSAI) that indicates which S-NSSAI(s) is used as the default S-NSSAI(s).
Option 3: The NSSF includes the subscribed S-NSSAIs marked as default S-NSSAI(s) as a candidate to be registered and also registers the subscribed S-NSSAIs (i.e., include the Subscribed S-NSSAIs in the allowed NSSAI).
Option 4: As per standard flow
   Step 708—The AMF accepts the registration with Registration Accept (e.g., step 508).
Option 1: The Registration Accept includes the S-NSSAI(s) marked as default S-NSSAI(s), and the UE will store the S-NSSAI(s) as the default S-NSSAI(s) for later use.
Option 2: The network may provide the UE with the configured NSSAI (and/or allowed NSSAI) that indicates which S-NSSAI(s) is used as the default S-NSSAIs.
Option 3: The network may provide the UE with the allowed NSSAI that includes the S-NSSAI(s) that is used as the default S-NSSAI(s), and may optionally mark which S-NSSAI(s) is the default S-NSSAI(s) such that the UE can know which S-NSSAI(s) is the default S-NSSAI(s) for later use.
Option 4: As per standard flow

### Default Subscribed S-NSSAI Request Indication

### 9.11.3.36 Network Slicing Indication

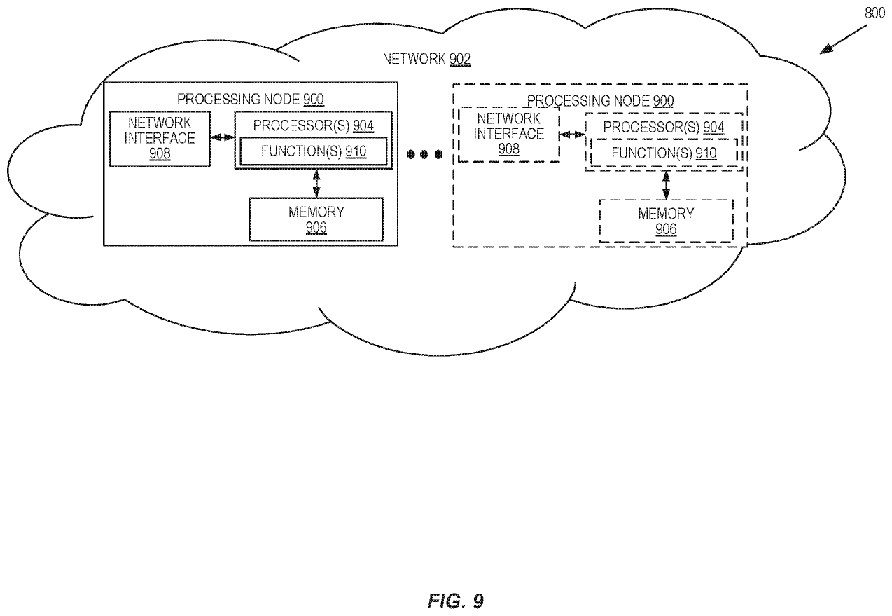

The purpose of the Network slicing indication information element is to indicate additional information associated with network slicing in the generic UE configuration update procedure and the registration procedure, other than the user's configured NSSAI, allowed NSSAI and rejected NSSAI information.
The Network slicing indication information element is coded as shown in FIG. 9.11.3.36.1 and table 9.11.3.36.1.
The Network slicing indication is a type 1 information element.

| | | | | | | | |
|---|---|---|---|---|---|---|---|
| 8 | 7 | 6 | 5 | 4 | 3 | 2 | 1 |

| | | | | | |
|---|---|---|---|---|---|
| Network slicing indication | 0 | [symbol] | DCNI | NSSCI | octet 1 |
| IEI | Spare | [symbol] | | | |
| | | DSSRI | | | |

FIG. 9.11.3.36.1: Network Slicing Indication

TABLE 9.11.3.36.1
Network slicing indication

Network slicing subscription change indication (NSSCI) (octet 1,
bit 1)
Bit
1
0 Network slicing subscription not changed
1 Network slicing subscription changed
Default configured NSSAI indication (DCNI) (octet 1, bit 2)
Bit
2
0 Requested NSSAI not created from default configured NSSAI
1 Requested NSSAI created from default configured NSSAI
In the UE to network direction bit 1 is spare. The UE shall set this
bit to zero.
In the network to UE direction bit 2 is spare. The network shall
set this bit to zero.
Default subscribed S-NSSAI request indication (octet 1, bit 3)
Bit
3
0 Default subscribed S-NSSAI not requested.
1 Default subscribed S-NSSAI requested.
Bits [symbol] 4 [symbol] is spare and shall be coded as zero.

### Default Subscribed S-NSSAIs Information Element

An example of the indication for allowed NSSAI or Configured NSSAI. It is complex to change the allowed NSSAI IE and Configured NSSAI themselves to include this indication with regards to backward compatibility issues.

### 8.2.7.1 Message Definition

TABLE 8.2.7.1.1
REGISTRATION ACCEPT message content

| IEI | Information Element | Type/Reference | Presence | Format | Length |
|---|---|---|---|---|---|
| | Extended protocol | Extended protocol | M | V | 1 |
| | discriminator | discriminator | | | |
| | | 9.2 | | | |
| | Security header type | Security header type | M | V | 1/2 |
| | | 9.3 | | | |
| | Spare half octet | Spare half octet | M | V | 1/2 |
| | | 9.5 | | | |
| | Registration accept | Message type | M | V | 1 |
| | message identity | 9.7 | | | |
| | 5GS registration result | 5GS registration result | M | LV | 2 |
| | | 9.11.3.6 | | | |
| 77 | 5G-GUTI | 5GS mobile identity | O | TLV-E | 14 |
| | | 9.11.3.4 | | | |
| 4A | Equivalent PLMNs | PLMN list | O | TLV | 5-47 |
| | | 9.11.3.45 | | | |
| 54 | TAI list | 5GS tracking area identity | O | TLV | 9-114 |
| | | list | | | |
| | | 9.11.3.9 | | | |
| 15 | Allowed NSSAI | NSSAI | O | TLV | 4-74 |
| | | 9.11.3.37 | | | |
| 11 | Rejected NSSAI | Rejected NSSAI | O | TLV | 4-42 |
| | | 9.11.3.46 | | | |
| 31 | Configured NSSAI | NSSAI | O | TLV | 4-146 |
| | | 9.11.3.37 | | | |
| 21 | 5GS network feature | 5GS network feature | O | TLV | 3-5 |
| | support | support | | | |
| | | 9.11.3.5 | | | |
| 50 | PDU session status | PDU session status | O | TLV | 4-34 |
| | | 9.11.3.44 | | | |
| 26 | PDU session reactivation | PDU session reactivation | O | TLV | 4-34 |
| | result | result | | | |
| | | 9.11.3.42 | | | |
| 72 | PDU session reactivation | PDU session reactivation | O | TLV-E | 5-515 |
| | result error cause | result error cause | | | |
| | | 9.11.3.43 | | | |
| 79 | LADN information | LADN information | O | TLV-E | 12-1715 |
| | | 9.11.3.30 | | | |
| B- | MICO indication | MICO indication | O | TV | 1 |
| | | 9.11.3.31 | | | |
| 9- | Network slicing indication | Network slicing indication | O | TV | 1 |
| | | 9.11.3.36 | | | |
| 27 | Service area list | Service area list | O | TLV | 6-114 |
| | | 9.11.3.49 | | | |
| 5E | T3512 value | GPRS timer 3 | O | TLV | 3 |
| | | 9.11.2.5 | | | |
| 5D | Non-3GPP de-registration | GPRS timer 2 | O | TLV | 3 |
| | timer value | 9.11.2.4 | | | |
| 16 | T3502 value | GPRS timer 2 | O | TLV | 3 |
| | | 9.11.2.4 | | | |
| 34 | Emergency number list | Emergency number list | O | TLV | 5-50 |
| | | 9.11.3.23 | | | |
| 7A | Extended emergency | Extended emergency | O | TLV-E | 7-65538 |
| | number list | number list | | | |
| | | 9.11.3.26 | | | |
| 73 | SOR transparent | SOR transparent container | O | TLV-E | 20-n |
| | container | 9.11.3.51 | | | |
| 78 | EAP message | EAP message | O | TLV-E | 7-1503 |
| | | 9.11.2.2 | | | |
| A- | NSSAI inclusion mode | NSSAI inclusion mode | O | TV | 1 |
| | | 9.11.3.37A | | | |
| 76 | Operator-defined access | Operator-defined access | O | TLV-E | 3-n |
| | category definitions | category definitions | | | |
| | | 9.11.3.38 | | | |
| 51 | Negotiated DRX | 5GS DRX parameters | O | TLV | 3 |
| | parameters | 9.11.3.2A | | | |
| D- | Non-3GPP NW policies | Non-3GPP NW provided | O | TV | 1 |
| | | policies | | | |
| | | 9.11.3.36A | | | |
| 60 | EPS bearer context status | EPS bearer context status | O | TLV | 4 |
| | | 9.11.3.23A | | | |
| 6E | Negotiated extended DRX | Extended DRX parameters | O | TLV | 3 |
| | parameters | 9.11.3.26A | | | |
| 6C | T3447 value | GPRS timer 3 | O | TLV | 3 |
| | | 9.11.2.5 | | | |
| 6B | T3448 value | GPRS timer 3 | O | TLV | 3 |
| | | 9.11.2.4 | | | |
| 6A | T3324 value | GPRS timer 3 | O | TLV | 3 |
| | | 9.11.2.5 | | | |
| 67 | UE radio capability ID | UE radio capability ID | O | TLV | 3-n |
| | | 9.11.3.68 | | | |
| 68 | UE radio capability ID | UE radio capability ID | O | TV | 1 |
| | deletion indication | deletion indication | | | |
| | | 9.11.3.69 | | | |
| 39 | Pending NSSAI | NSSAI | O | TLV | 4-74 |
| | | 9.11.3.37 | | | |
| 74 | Ciphering key data | Ciphering key data | O | TLV-E | x-n |
| | | 9.11.3.18C | | | |
| 75 | CAG information list | CAG information list | O | TLV-E | 3-n |
| | | 9.11.3.18A | | | |
| 1B | Truncated 5G-S-TMSI | Truncated 5G-S-TMSI | O | TLV | 3 |
| | configuration | configuration | | | |
| | | 9.11.3.70 | | | |
| 1C | Negotiated WUS | WUS assistance information | O | TLV | 3-n |
| | assistance information | 9.11.3.71 | | | |
| Xx | Default subscribed NSSAI | Default subscribed NSSAI | O | TLV | 3-42 |
| | | 9.11.3.x | | | |

### 9.11.3.x Default Subscribed NSSAI

The purpose of the Default subscribed NSSAI information element is to indicate the default subscribed S-NSSAI(s) provided in Configured NSSAI IE or Allowed NSSAI IE or both.
The Default subscribed NSSAI information element is coded as shown in FIG. 9.11.3.x.1, FIG. 9.11.3.x.2 and table 9.11.3.x.1.
The Default subscribed NSSAI is a type 4 information element with a minimum length of 4 octets and a maximum length of 42 octets.

| | | | | | | | |
|---|---|---|---|---|---|---|---|
| 8 | 7 | 6 | 5 | 4 | 3 | 2 | 1 |

| | |
|---|---|
| Default subscribed NSSAI IEI | octet 1 |
| Length of Default subscribed NSSAI contents | octet 2 |
| Default subscribed S-NSSAI content 1 | octet 3 |
| | octet m |
| Default subscribed S-NSSAI content 2 | octet m + 1* |
| | octet n* |
| . . . | octet n + 1* |
| | octet u* |
| Default subscribed S-NSSAI content n | octet u + 1* |
| | octet v* |

FIG. 9.11.3.x.1: Default Subscribed NSSAI Information Element

| | | | | | | | |
|---|---|---|---|---|---|---|---|
| 8 | 7 | 6 | 5 | 4 | 3 | 2 | 1 |

| | |
|---|---|
| Length of Default subscribed S-NSSAI content | octet 3 |
| HPLMN SST | octet 4 |
| HPLMN SD | octet 5* |
| | octet 7* |

FIG. 9.11.3.x.2: Default Subscribed S-NSSAI Content

TABLE 9.11.3.x.1
Default subscribed NSSAI information element

Value part of the Mapped NSSAI information element (octet 3 to v)
The value part of the Mapped NSSAI information element consists of
one or more default subscribed S-NSSAI contents.
Default subscribed S-NSSAI content:
Length of Default subscribed S-NSSAI contents (octet 3)
HPLMN Slice/service type (SST) (octet 4)
This field contains the 8 bit SST value of an S-NSSAI in the S-
NSSAI(s) of the HPLMN. The coding of the SST value part is defined
in 3GPP TS 23.003 [4].
NOTE 1: Octet 4 (i.e. HPLMN SST) shall always be included.
HPLMN Slice differentiator (SD) (octet 5 to octet 7)
This field contains a 24-bit SD value of an S-NSSAI in the S-NSSAI(s)
of the HPLMN. The coding of the SD value part is defined in 3GPP TS
23.003 [4].
NOTE 2: If the octet 5 is included, then octet 6 and octet 7 shall
be included.

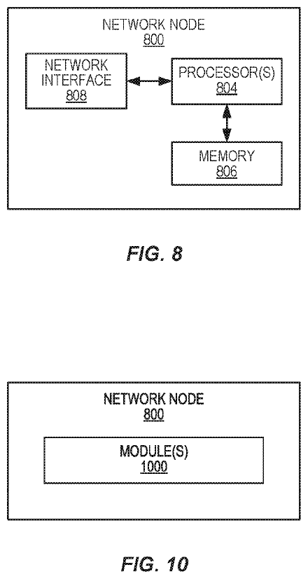

FIG. 8 is a schematic block diagram of a network node 800 according to some embodiments of the present disclosure. The network node 800 may be, for example, a core network node (e.g., SMF, PCF, PGW-C, PCRF). As illustrated, the network node 800 includes one or more processors 804 (e.g., Central Processing Units (CPUs), Application Specific Integrated Circuits (ASICs), Field Programmable Gate Arrays (FPGAs), and/or the like), memory 806, and a network interface 808. The one or more processors 804 are also referred to herein as processing circuitry. The one or more processors 804 operate to provide one or more functions of the network node 800 as described herein (e.g., one or more functions of SMF, PCF, PGW-C, PCRF as described herein). In some embodiments, the function(s) are implemented in software that is stored, e.g., in the memory 806 and executed by the one or more processors 804.

FIG. 9 is a schematic block diagram that illustrates a virtualized embodiment of the network node 800 according to some embodiments of the present disclosure. Optional features are represented by dashed boxes. As used herein, a “virtualized” network node is an implementation of the network node 800 in which at least a portion of the functionality of the network node 800 is implemented as a virtual component(s) (e.g., via a virtual machine(s) executing on a physical processing node(s) in a network(s)). As illustrated, in this example, the network node 800 includes one or more processing nodes 900 coupled to or included as part of a network(s) 902. Each processing node 900 includes one or more processors 904 (e.g., CPUs, ASICs, FPGAs, and/or the like), memory 906, and a network interface 908. In this example, functions 910 of the network node 800 described herein (e.g., one or more functions of SMF, PCF, PGW-C, PCRF as described herein) are implemented at the one or more processing nodes 900 or distributed across the two or more processing nodes 900 in any desired manner. In some particular embodiments, some or all of the functions 910 of the network node 800 described herein are implemented as virtual components executed by one or more virtual machines implemented in a virtual environment(s) hosted by the processing node(s) 900.

In some embodiments, a computer program including instructions which, when executed by at least one processor, causes the at least one processor to carry out the functionality of the network node 800 or a node (e.g., a processing node 900) implementing one or more of the functions 910 of the network node 800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 10 is a schematic block diagram of the network node 800 according to some other embodiments of the present disclosure. The network node 800 includes one or more modules 1000, each of which is implemented in software. The module(s) 1000 provide the functionality of the network node 800 described herein. This discussion is equally applicable to the processing node 900 of FIG. 9 where the modules 1000 may be implemented at one of the processing nodes 900 or distributed across multiple processing nodes 900.

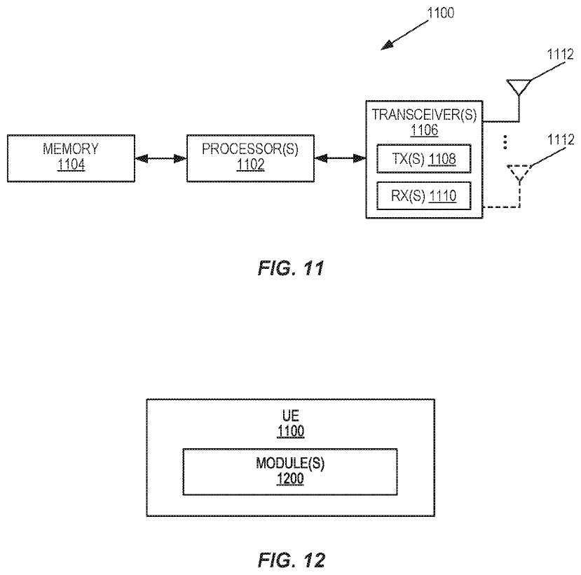

FIG. 11 is a schematic block diagram of a wireless communication device 1100 according to some embodiments of the present disclosure. As illustrated, the wireless communication device 1100 includes one or more processors 1102 (e.g., CPUs, ASICs, FPGAs, and/or the like), memory 1104, and one or more transceivers 1106 each including one or more transmitters 1108 and one or more receivers 1110 coupled to one or more antennas 1112. The transceiver(s) 1106 includes radio-front end circuitry connected to the antenna(s) 1112 that is configured to condition signals communicated between the antenna(s) 1112 and the processor(s) 1102, as will be appreciated by one of ordinary skill in the art. The processors 1102 are also referred to herein as processing circuitry. The transceivers 1106 are also referred to herein as radio circuitry. In some embodiments, the functionality of the wireless communication device 1100 described above may be fully or partially implemented in software that is, e.g., stored in the memory 1104 and executed by the processor(s) 1102. Note that the wireless communication device 1100 may include additional components not illustrated in FIG. 11 such as, e.g., one or more user interface components (e.g., an input/output interface including a display, buttons, a touch screen, a microphone, a speaker(s), and/or the like and/or any other components for allowing input of information into the wireless communication device 1100 and/or allowing output of information from the wireless communication device 1100), a power supply (e.g., a battery and associated power circuitry), etc.

In some embodiments, a computer program including instructions which, when executed by at least one processor, causes the at least one processor to carry out the functionality of the wireless communication device 1100 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the wireless communication device 1100 according to some other embodiments of the present disclosure. The wireless communication device 1100 includes one or more modules 1200, each of which is implemented in software. The module(s) 1200 provides the functionality of the wireless communication device 1100 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some exemplary embodiments of the present disclosure are as follows.

Embodiment 1: A method performed by a communication device (e.g., UE) for determining a default network slice (e.g., for establishing a protocol data unit, PDU, session) is provided. The method includes one or more of determining (600) a default Single Network Slice Selection Assistance Information, S-NSSAI, that identifies a default network slice and establishing (602) a PDU session in the default network slice identified by the default S-NSSAI (e.g., that the UE explicitly indicates or not explicitly indicates (e.g., pre-registered with the network)) for an application without S-NSSAI association.

Embodiment 2: Determining (600) the default S-NSSAI comprising one or more of: registering (600a-1) with a network (e.g., 5GC) without sending any Requested NSSAI (e.g., to a specific PLMN), receiving (600a-2) an Allowed NSSAI identifying one or more default S-NSSAIs from the network, and storing (600a-3) the one or more default S-NSSAIs. Establishing (602) the PDU session comprising one or more of: sending (602a-1) a new Registration request, receiving (602a-2) a new Allowed NSSAI, and providing (602d) a PDU Session Establishment without providing any S-NSSAI or with the default S-NSSAI. Sending (602a-1) a new Registration request includes one or more of: the one or more stored default S-NSSAIs and a previously registered default S-NSSAI (e.g., to keep the previously registered default S_NSSAI registered). Receiving (602a-2) a new Allowed NSSAI includes one or more of: the one or more stored default S-NSSAIs and the previously registered default S-NSSAI (if included in the new Registration request).

Embodiment 3: Determining (600) the default S-NSSAI comprising one or more of: receiving (600b-1) a Configured NSSAI (e.g., in Registration Accept or UE Configuration Update Command) including one or more S-NSSAIs marked as default S-NSSAIs and store (600b-2) the one or more default S-NSSAIs. Establishing (602) the PDU session comprising one or more of: sending (602b-1) a new registration request to add a specific one of the one or more stored default S-NSSAIs as the default S-NSSAI and providing (602d) a PDU Session Establishment without providing any S-NSSAI or with the default S-NSSAI.

Embodiment 4: Determining (600) the default S-NSSAI comprising pre-registering (600c-1) a specific S-NSSAI(s) with the network. Establishing (602) the PDU session comprising one or more of: sending (602c-1) a new Registration request with a Requested NSSAI including the pre-registered S-NSSAI(s) and an indication to register one or more S-NSSAIs marked as default S-NSSAI(s), receiving (602c-2) an allowed NSSAI from the network, and providing (602d) a PDU Session Establishment without providing any S-NSSAI or with the default S-NSSAI. Receiving (602a-2) an allowed NSSAI from the network including one or more of: the pre-registered S-NSSAI(s), the one or more S-NSSAIs marked as default S-NSSAIs (e.g., marked as default S-NSSAI at UDM), and an indication that indicates the default S-NSSAI.

Embodiment 5: Determining (600) the default S-NSSAI comprising one or more of: receiving (600d-1) a URSP rule (e.g., having a lowest Rule Precedence priority that includes a match-all Traffic Descriptor) associated with a respective S-NSSAI and using (600d-2) the respective S-NSSAI associated with the URSP rule as the default S-NSSAI. Establishing (602) the PDU session comprising providing (602d) a PDU Session Establishment without providing any S-NSSAI or with the default S-NSSAI.

Embodiment 6: A method performed by a network (e.g., 5GC) for determining a default network slice for establishing a protocol data unit, PDU, session is provided. The method includes one or more of: receiving (700) a registration request from a communication device (e.g., UE) including a requested NSSAI or without a request NSSAI, receiving (702) (e.g., at AMF) subscription information (e.g., from UDM) including one or more subscribed S-NSSAIs, and sending (708) (e.g., from the AMF) a registration accept message to the wireless device. The registration accept message includes one or more of the following: one or more default S-NSSAIs, a Configured NSSAI and/or an Allowed NSSAI that indicate the one or more default S-NSSAIs, and an Allowed NSSAI including the one or more default S-NSSAIs with an optional marking for one of the one or more default S-NSSAIs.

Embodiment 7: The method also includes requesting (704) (e.g., by AMF) a network slice selection (e.g., by sending Nnssf_NSSelection_Get Request to the NSSF) and receiving (706) a response (e.g., Nnssf_NSSelection_Get Response from NSSF).

Embodiment 8: A wireless device for determining a default network slice for establishing a protocol data unit, PDU, session is provided. The wireless device includes processing circuitry configured to perform any of the steps in the method performed by the wireless device. The wireless device also includes power supply circuitry configured to supply power to the wireless device.

Embodiment 9: A base station for determining a default network slice for establishing a protocol data unit, PDU, session is provided. The base station includes processing circuitry configured to perform any of the steps in the method performed by the base station. The base station also includes power supply circuitry configured to supply power to the base station.

Embodiment 10: A User Equipment, UE, for determining a default network slice for establishing a protocol data unit, PDU, session is provided. The UE includes an antenna configured to send and receive wireless signals. The UE also includes radio front-end circuitry connected to the antenna and to processing circuitry and configured to condition signals communicated between the antenna and the processing circuitry. The UE also includes the processing circuitry being configured to perform any of the steps in the method performed by the wireless device. The UE also includes an input interface connected to the processing circuitry and configured to allow input of information into the UE to be processed by the processing circuitry. The UE also includes an output interface connected to the processing circuitry and configured to output information from the UE that has been processed by the processing circuitry. The UE also includes a battery connected to the processing circuitry and configured to supply power to the UE.

Embodiment 11: A communication system is provided. The communication system includes a host computer. The host computer includes processing circuitry configured to provide user data. The host computer also includes a communication interface configured to forward the user data to a cellular network for transmission to a User Equipment, UE. The cellular network includes a base station having a radio interface and processing circuitry. The base station's processing circuitry is configured to perform any of the steps in the method performed by the base station.

Embodiment 12: The communication system further includes the base station.

Embodiment 13: The communication system further includes the UE, wherein the UE is configured to communicate with the base station.

Embodiment 14: The processing circuitry of the host computer is configured to execute a host application, thereby providing the user data. The UE comprises processing circuitry configured to execute a client application associated with the host application.

Embodiment 15: A method implemented in a communication system including a host computer, a base station, and a User Equipment, UE is provided. The method includes at the host computer, providing user data. The method also includes at the host computer, initiating a transmission carrying the user data to the UE via a cellular network comprising the base station, wherein the base station performs any of the steps of any of the steps in the method performed by the base station.

Embodiment 16: The method also includes at the base station, transmitting the user data.

Embodiment 17: The user data is provided at the host computer by executing a host application. The method also includes, at the UE, executing a client application associated with the host application.

Embodiment 18: A User Equipment, UE, configured to communicate with a base station. The UE includes a radio interface and processing circuitry configured to perform the method of embodiments 15 to 17.

Embodiment 19: A communication system including a host computer. The host computer includes processing circuitry configured to provide user data and a communication interface configured to forward user data to a cellular network for transmission to a User Equipment, UE. The UE includes a radio interface and processing circuitry, the UE's components are configured to perform any of the steps in the method performed by the wireless device.

Embodiment 20: The cellular network further includes a base station configured to communicate with the UE.

Embodiment 21: The processing circuitry of the host computer is configured to execute a host application, thereby providing the user data. The UE's processing circuitry is configured to execute a client application associated with the host application.

Embodiment 22: A method implemented in a communication system including a host computer, a base station, and a User Equipment, UE. The method includes at the host computer, providing user data. The method also includes at the host computer, initiating a transmission carrying the user data to the UE via a cellular network comprising the base station, wherein the UE performs any of the steps in the method performed by the wireless device.

Embodiment 23: The method also includes at the UE, receiving the user data from the base station.

Embodiment 24: A communication system including a host computer. The host computer includes a communication interface configured to receive user data originating from a transmission from a User Equipment, UE, to a base station. The UE comprises a radio interface and processing circuitry, the UE's processing circuitry is configured to perform any of the steps in the method performed by the wireless device.

Embodiment 25: The communication system further includes the UE.

Embodiment 26: The communication system further includes the base station, wherein the base station comprises a radio interface configured to communicate with the UE and a communication interface configured to forward to the host computer the user data carried by a transmission from the UE to the base station.

Embodiment 27: The processing circuitry of the host computer is configured to execute a host application. The UE's processing circuitry is configured to execute a client application associated with the host application, thereby providing the user data.

Embodiment 28: The processing circuitry of the host computer is configured to execute a host application, thereby providing request data. The UE's processing circuitry is configured to execute a client application associated with the host application, thereby providing the user data in response to the request data.

Embodiment 29: A method implemented in a communication system including a host computer, a base station, and a User Equipment, UE. The method includes at the host computer, receiving user data transmitted to the base station from the UE. The UE performs any of the steps in the method performed by the wireless device.

Embodiment 30: The method further includes, at the UE, providing the user data to the base station.

Embodiment 31: The method further includes at the UE, executing a client application, thereby providing the user data to be transmitted. The method further includes at the host computer, executing a host application associated with the client application.

Embodiment 32: The method further includes at the UE, executing a client application. The method further includes at the UE, receiving input data to the client application, the input data being provided at the host computer by executing a host application associated with the client application. The user data to be transmitted is provided by the client application in response to the input data.

Embodiment 33: A communication system including a host computer comprising a communication interface configured to receive user data originating from a transmission from a User Equipment, UE, to a base station. The base station includes a radio interface and processing circuitry. The base station's processing circuitry is configured to perform any of the steps in the method performed by the base station.

Embodiment 34: The communication system further includes the base station.

Embodiment 35: The communication system further includes the UE. The UE is configured to communicate with the base station.

Embodiment 36: The processing circuitry of the host computer is configured to execute a host application. The UE is configured to execute a client application associated with the host application, thereby providing the user data to be received by the host computer.

Embodiment 37: A method implemented in a communication system including a host computer, a base station, and a User Equipment, UE. The method includes at the host computer, receiving, from the base station, user data originating from a transmission which the base station has received from the UE. The UE performs any of the steps in the method performed by the wireless device.

Embodiment 38: The method further includes at the base station, receiving the user data from the UE.

Embodiment 39: The method further includes at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CP Control Plane
CPU Central Processing Unit
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HPLMN Home Public Land Mobile Network
HSS Home Subscriber Server
IoT Internet of Things
IP Internet Protocol
LTE Long Term Evolution
MME Mobility Management Entity
MTC Machine Type Communication
NEF Network Exposure Function
NF Network Function
NG-RAN Next Generation Radio Access Network
NR New Radio
NRF Network Function Repository Function
NSSF Network Slice Selection Function
OTT Over-the-Top
PC Personal Computer
PCF Policy Control Function
PDU Protocol Data Unit
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SD Slice Differentiator
SMF Session Management Function
S-NSSAI Single Network Slice Selection Assistance Information
SST Slice/Service Type
UDM Unified Data Management
UE User Equipment
UPF User Plane Function
URSP UE Route Selection Policy

Those skilled in the art will recognize improvements and modifications to the embodiments of the present disclosure. All such improvements and modifications are considered within the scope of the concepts disclosed herein.

1. A wireless device for determining a default network slice, the wireless device comprising processing circuitry configured to cause the wireless device to:
determine a default Single Network Slice Selection Assistance Information, S-NSSAI, that identifies a default network slice; and
establish a Protocol Data Unit, PDU, session in the default network slice identified by the default S-NSSAI for an application without an S-NSSAI association.

2. The wireless device of claim 1, wherein in order to determine the default S-NSSAI the processing circuitry is further configured to cause the wireless device to:
register with a network node without providing a requested NSSAI;
receive, from the network node, an allowed NSSAI comprising one or more subscribed S-NSSAIs; and
determine any of the one or more subscribed S-NSSAIs as the default S-NSSAI.

3. The wireless device of claim 1, wherein in order to determine the default S-NSSAI the processing circuitry is further configured to cause the wireless device to:
receive, from a network node, a configured NSSAI comprising one or more marked S-NSSAIs; and
determine any of the one or more marked S-NSSAIs as the default S-NSSAI.

4. The wireless device of claim 1, wherein in order to determine the default S-NSSAI the processing circuitry is further configured to cause the wireless device to:
send, to a network node, a registration request comprising an indication requesting the default S-NSSAI to be registered and identified among one or more pre-registered S-NSSAIs for an allowed NSSAI; and
receive, from the network node, the allowed NSSAI comprising one or more S-NSSAIs marked as default S-NSSAI.

5. The wireless device of claim 1, wherein in order to determine the default S-NSSAI the processing circuitry is further configured to cause the wireless device to receive, from a network node, a User Equipment, UE, Route Selection Policy, URSP, rule associated with the default S-NSSAI.

6. The wireless device of claim 1, wherein in order to establish the PDU session, the processing circuitry is further configured to send a new registration request comprising the default S-NSSAI.

7. The wireless device of claim 6, wherein the new registration request further comprises one or more specific S-NSSAIs different from the default S-NSSAI.

8. The wireless device of claim 6, wherein in order to establish the PDU session, the processing circuitry is further configured to provide a PDU session establishment request to the network node.

9. The wireless device of claim 8, wherein the PDU session establishment request comprises the default S-NSSAI.

10. The wireless device of claim 8, wherein the PDU session establishment request does not comprise the default S-NSSAI.

11. A method performed by a wireless device for determining a default network slice, the method comprising:
determining a default Single Network Slice Selection Assistance Information, S-NSSAI, that identifies a default network slice; and
establishing a Protocol Data Unit, PDU, session in the default network slice identified by the default S-NSSAI for an application without an S-NSSAI association.

12. (canceled)

13. A method performed by an Access and Mobility Function, AMF, for determining a default network slice, comprising:
receiving a registration request from a wireless device; and
sending, to the wireless device, a registration accept message comprising any one of:
an allowed NSSAI comprising one or more subscribed S-NSSAIs;
a configured NSSAI comprising one or more marked S-NSSAIs;
the allowed NSSAI comprising one or more S-NSSAIs marked as default S-NSSAI; and
a User Equipment, UE, Route Selection Policy, URSP, rule associated with the default S-NSSAI.

14. The method of claim 13, wherein the registration request does not comprise a requested NSSAI.

15. The method of claim 13, wherein the registration request comprises an indication requesting a default S-NSSAI to be registered and identified among one or more pre-registered S-NSSAIs for an allowed NSSAI.

16. The method of claim 13, further comprising receiving, from a Unified Data Management, UDM, subscription information comprising the one or more subscribed S-NSSAIs.

17. The method of claim 13, further comprising:
sending a request to a Network Slice Selection Function, NSSF, to request a network slice selection; and
receiving a response from the NSSF comprising the network slice selection.

18. The method of claim 17, wherein:
the request comprises an indication to register the one or more subscribed S-NSSAIs; and
the response comprises one of:
the one or more subscribed S-NSSAIs; and
the one or more marked S-NSSAIs.

19. (canceled)

20. (canceled)

21. The method of claim 11, wherein determining the default S-NSSAI:
registering with a network node without providing a requested NSSAI;
receiving, from the network node, an allowed NSSAI comprising one or more subscribed S-NSSAIs; and
determining any of the one or more subscribed S-NSSAIs as the default S-NSSAI.

22. The method of claim 11, wherein determining the default S-NSSAI:
receiving, from a network node, a configured NSSAI comprising one or more marked S-NSSAIs; and
determining any of the one or more marked S-NSSAIs as the default S-NSSAI.
